(19) United States
(12) Patent Application Publication
(10) Pub. No.: US 2005/0251956 A1
(43) Pub. Date: Nov. 17, 2005

(54) Castor mounting arrangement for a load bearing vehicle

(76) Inventors: Stephen Wintersgill, Rochdale (GB); John Robinson, Rochdale (GB)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 10/514,769

(22) PCT Filed: May 16, 2003
(86) PCT No.: PCT/GB03/02137

§ 371 Date: Nov. 17, 2004

(30) Foreign Application Priority Data
May 17, 2002 (GB) 0211228.2

(51) Int. Cl. B60B 33/00

(52) U.S. Cl. 16/31 R; 16/18 R

(57) ABSTRACT

A pair of castors is connected to the chassis of a trolley or the like by a castor mounting arrangement. A fixed member is connected to a rotating member via a hinged connection that has an elongate substantially cylindrical member and a hinge roll. Primary stop means limits articulation in both rotational directions.

The present invention relates to a castor mounting arrangement for a load-bearing vehicle. In particular it relates to a castor mounting arrangement suitable for use on carts and trolleys of the type provided in retail outlets such as supermarkets and DIY superstores and luggage trolleys such as those found at airports and railway stations.

Supermarket shopping trolleys are usually provided with four identical swivel castors. A traditional castor comprises a wheel having an axle (which defines axis of rotation of the wheel) that is mounted on a wheel mount, which, in turn, is free to swivel about a substantially vertical axis. The rotation axis of the wheel is offset horizontally from the swivel axis so as to provide a stable arrangement in which the wheel's axle will tend to trail the swivel axis when a horizontal motive force is applied to the mount, the axle tending to align perpendicularly to the direction of motion.

When a trolley having such a castor arrangement, such as that described above, is not loaded it is relatively easy to steer since it is relatively light and the force required to pivot the trolley about its centre of gravity is relatively low. However, if the load in the trolley in increased, the forces required to effect changes of direction increase also, and two main problems become apparent.

First, when pushing a trolley across a gradient, as is commonly found in supermarket car parks and loading areas, gravity acts on the load and in conjunction with the gradient produces a resultant side force which tends to push the trolley front down the gradient, rather than allowing it to traverse across. As the trolley front is the more difficult to control due to the distant centre of mass, front-end drift occurs with the castors aligning themselves down the incline as the trolley front runs away from the user. The only corrective action possible is for the person pushing the trolley to attempt to push the rear of the trolley further down the slope than the trolley front in order to move around and underneath the centre of mass and push up as well as across the gradient in order to keep the trolley moving in a straight line. This is often very difficult to do, as pushing the rear of the trolley down the slope merely increases the tendency of the trolley front to move down the gradient resulting in a downward drift that is difficult to arrest.

Secondly, as the load is increased it becomes more difficult to manoeuvre the trolley around corners. This is because there is no fulcrum for the trolley to steer about, as all the castors are free to swivel. This means that to turn a 180 degree corner, as found at the end of most supermarket aisles, the user has to walk around the mass of the trolley, pushing the rear of the trolley outwards, then realigning the trolley to the new direction of travel. This often involves approaching the corner along a wider arc than is necessary, since the momentum of the trolley tends to continue to push the trolley front onwards and away from the desired course, with the front castors duly following the onward tendency of the trolley creating an understeering effect.

There have been many attempts in recent years to overcome these steering problems, however, none has been entirely successful or satisfactory. The more recent ideas have been focussed towards improving the tracking of the castors, i.e. their propensity to stay correctly aligned during forward motion of the trolley. Two basic principals have been adopted. First, the swivelling action has been prevented by, for example, a retaining peg and slot mechanism, or a ball and socket or cam acting directly on to a spring. Secondly, the generation of a self-centring effect by tilting the castor swivel axis forwards and away from the vertical, such that the trolley is raised up from its lowest potential energy position whenever the castors are not aligned to trail the trolley in a forwards direction, thereby utilising gravity and the mass of the trolley to keep the castors in the desired alignment. The tilting introduces a so-called castor angle. The second principle is now taken to be superior, due to the softer application of steering force, and the absence of high lateral forces required to break the trolley out of the steering mode and into a free sideways or manoeuvring mode.

Our international patent application WO02/092408 describes, in general terms, a mobile load carrier with a castor mounting arrangement. The front castors of the carrier are connected to the chassis by a hinged mechanism. It is an object of the present invention to provide for an improved hinged mechanism in such a castor mounting arrangement.

According to a first aspect of the present invention there is provided a castor mounting arrangement, for a castored, load-bearing vehicle, the arrangement comprising a fixed member for connection to the vehicle, a rotating member for connection at least one castor and primary stop means for limiting the amount of rotation of the rotating member in both directions, characterised in that the fixed member is connected to the rotating member by a hinged connection comprising an elongate substantially cylindrical member defined on one of the members and a hinge roll defined on the other of the members, the hinge roll partially enveloping the cylindrical member and being rotatable relative thereto.

The fixed member may be an integral part of the load-bearing vehicle or may be separately connectable to the vehicle.

The primary stop means preferably comprises a first abutment surface defined on said fixed member and a second abutment surface defined on said rotating member, the rotating member being movable in a first direction towards the fixed member to a first position where first and second abutment surfaces are in abutment and prevent any further rotation in that direction.

The first and second abutment surfaces are preferably defined at a position distal from said hinged connection.

The first and second abutment surfaces are preferably defined by first and second projections, the second projection being received, in use, in a space defined between the first projection and another part of the fixed member. The second projection may be defined on a rigid limb that is able to flex. The first and second projections preferably have arcuate surfaces that bear against and pass over one another during assembly of the fixed and rotating members.

The primary stop means may comprise a third abutment surface defined on the fixed member and a fourth abutment surface defined on the rotating member, rotating member being rotatable in a second direction away from the fixed member to a second position where the third and fourth abutment surfaces are in abutment and prevent any further rotation in that direction.

Ideally there is provided secondary stop means, said secondary stop means restricting the degree of rotation of the rotating member relative to the fixed member in either direction. The secondary stop means preferably comprises fifth and sixth abutment surfaces, one defined on the fixed member and the other defined on the rotating member. The secondary stop means ideally acts simultaneously with said primary stop means to restrict rotation of the rotating member in a first direction towards the fixed member.

Preferably there is provided a claw lock that prevents the hinge roll from uncurling. The claw lock may define part of the secondary stop means and it may define a fifth abutment surface and the hinge roll may define the sixth abutment surface.

The secondary stop means preferably does not act simultaneously with said primary stop means to restrict rotation of the rotating member in a second direction away from the fixed member but instead is present as a failsafe mechanism that restricts rotation in the second direction in the event of failure of said primary stop means.

A biasing member is preferably disposed between said fixed and said rotating member and may be formed from an elastomeric material.

The rotating member is preferably rotatable relative to the fixed member from a first position to a second position, the members being closer together in the second position, and the biasing member is under compression between said fixed and rotating members at the first position such that the arrangement withstand a predetermined load before rotation towards the second position commences.

According to a second aspect of the present invention there is provided a castor assembly for a load-bearing vehicle comprising at least one castor having a wheel that is rotatable about an axle and is swivel mounted on a swivel axis, and a castor mounting arrangement as defined above.

According to a third aspect of the present invention there is provided a load bearing vehicle comprising a chassis to which is connected a castor assembly as defined above.

According to a fourth aspect of the present invention there is provided a method for assembling a castor mounting arrangement having fixed and rotating members connectable by a hinged connection comprising a substantially cylindrical member being defined one of the fixed or rotating members and a hinge roll being defined on the other, the arrangement having primary stop means comprising a first projection on the fixed member and a second projection on the rotating member, the method comprising the steps attaching the fixed and rotating members at the hinged connection member such that the cylindrical member is received in and is partially enveloped by the hinge roll, rotating the rotating member about the hinge connection in a first direction towards the fixed member until the first and second projections contact one another, rotating the rotating member further in said first direction so that first and second projections slide past one another, further movement thereafter of the rotating member in either direction being limited.

The advantages offered by a device according to the present invention are several fold. First, the use of an fixed and rotating means with a hinge connection means the device can easily be extended to allow synchronous control of two or more castors, enhancing the stability of the load-bearing vehicle. Secondly, the use of a pinless hinge connection in the form of the substantially cylindrical member and the hinge roll reduces the number of parts in the device, thereby lowering cost and increasing efficiency in assembly. Thirdly, the design allows for much higher mechanical strength per unit of weight than conventional hinge manufacture, allowing higher load performance allied to an overall reduction in weight. Finally, the lack of a conventional permanently fixed hinge pin increases the ease with which the device can be refurbished or replaced.

A specific embodiment of the present invention will now be described, by way of example only, with reference to the accompanying drawings in which:

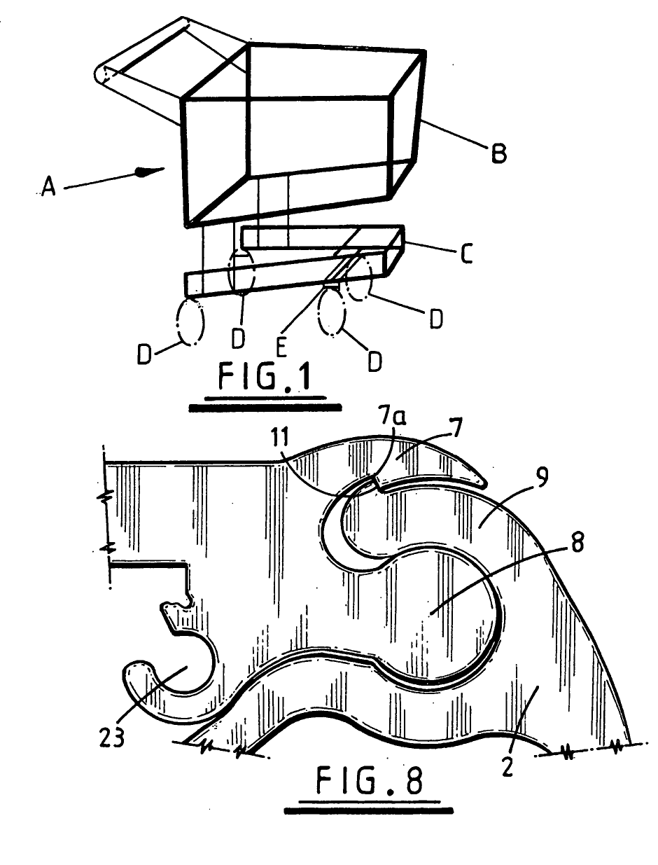

FIG. 1 is a schematic view of a load-bearing vehicle according to one aspect of the present invention;

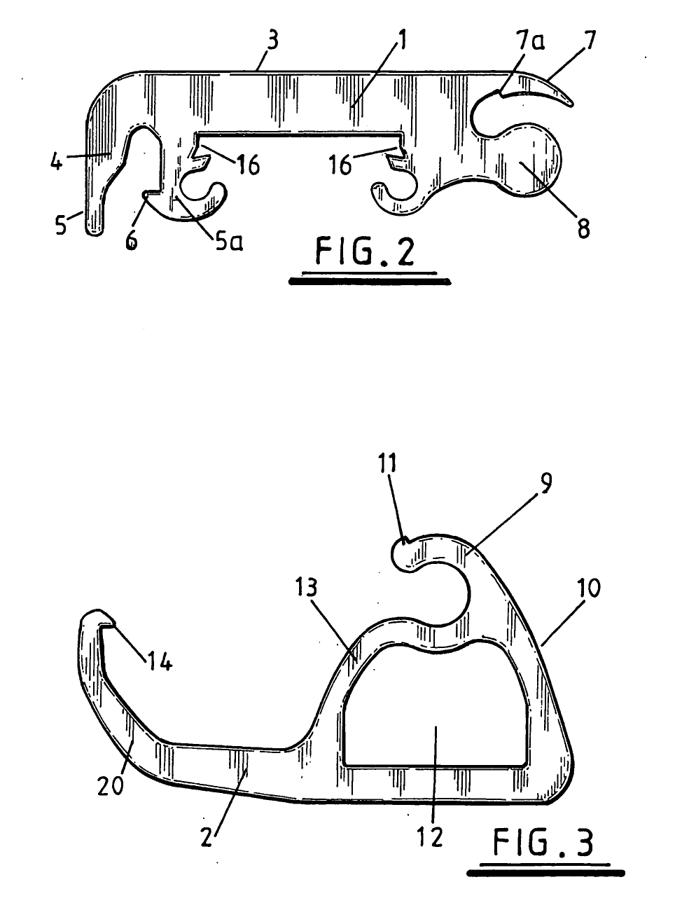

FIG. 2 is a sectioned side view of an upper hinge leaf of a castor mounting arrangement of the present invention;

FIG. 3 is a sectioned side view of a lower hinge leaf of the castor mounting arrangement of the present invention;

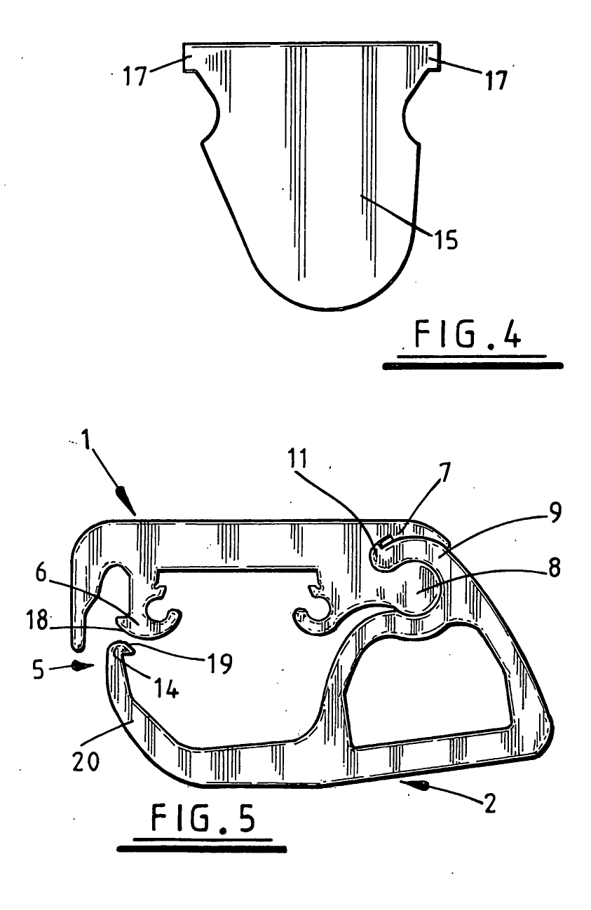

FIG. 4 is a sectioned side view of an elastomeric member forming part of the castor mounting arrangement of the present invention;

FIG. 5 is a sectioned side view of the assembled castor mounting arrangement shown in a first position;

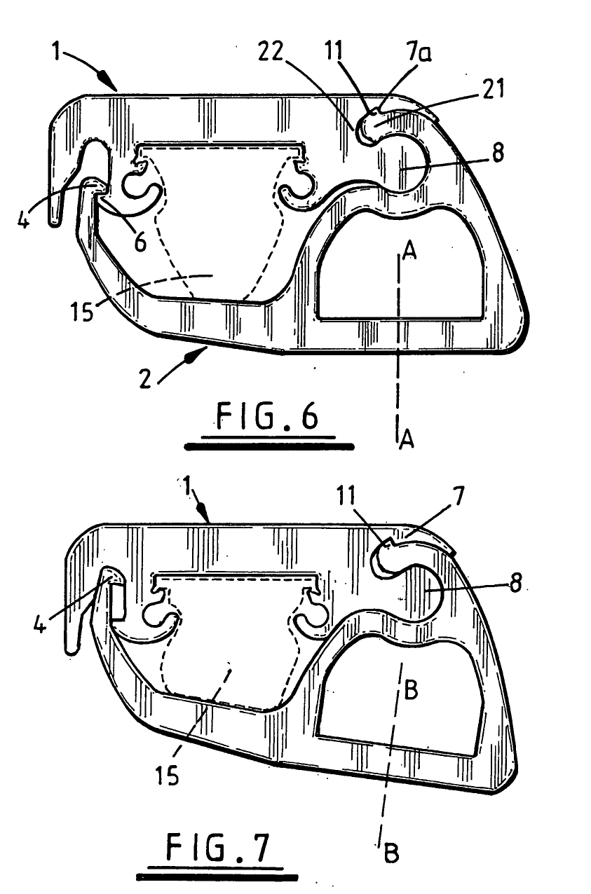

FIG. 6 is a sectioned side view of the castor mounting arrangement assembly of FIG. 5 shown in a second position;

FIG. 7 shows the arrangement of FIG. 5 in a third position; and

FIG. 8 is a close-up view of part of the castor mounting arrangement of FIG. 5.

The exemplary load-bearing vehicle A of the present invention is represented in the form of a shopping trolley in FIG. 1. The trolley has a load-carrying basket B supported on a chassis C by four castors D. The front castors are mounted on the trolley chassis by a castor mounting arrangement in the form of a hinged steering device E.

The hinged steering device E will now be described in detail with reference to FIG. 2 to 8. The device comprises upper and lower extruded hinge leaves 1, 2 having extruded profiles. The upper leaf 1 is connected to the underside of the trolley chassis C and the castors are connected to the lower leaf 2.

The upper leaf 1 has a main wall with a substantially planar upper surface 3 and a downward apron 4 along its rear edge 5. The underside of the main wall has a leg 5a extending substantially parallel to the apron 4 and having a lateral projection 6, the purpose of which will be described below. Along the front edge of leaf 1 is an arcuate extension defining claw lock feature 7 and below it a protruding substantially cylindrical member 8. A lower surface of the claw lock 7 has a shoulder 7a

The lower leaf 2 has a hinge roll portion 9 extending along the top of its front edge 10 comprising a recess with a principally circular cross section. The upper surface of the hinge roll portion 9 has a shoulder defining a claw lock feature 11 that is intended to interengage with the claw lock feature 7 on the upper leaf 1. The second profile 2 also has a tubular portion 12, designed to provide additional strength, with strut 13 providing increased torsional rigidity along the length of the profile. A limb 20 extends laterally from the tubular portion and terminates in an inwardly directly projection 14 that is shaped to engage interferingly with lateral projection 6.

FIG. 4 illustrates an elastomeric member 15 that is designed to slot into the first hinge leaf 1. The member has a pair of flanges 17 that are designed to fit into slots 16 in the underside of the upper leaf 1. With the elastomeric member 15 in place the two extruded leaves 1, 2 are assembled by slotting them together such that the cylindrical member 8 is receives and is partially enveloped by the hinge roll 9 and the claw lock features 7, 11 in a disengaged position as illustrated in FIG. 5. The hinged steering device is then clamped together towards its rear edge 5 such that a bottom surface 18 of the projection 6 comes into contact with a top surface 19 of the projection 14. As the clamping pressure is increased the projections pass over each other in a snap action, the limb 20 on the lower leaf 2 flexes and the surfaces 18, 19 slide past each other until the apex of portion 6 passes the apex of portion 14 and limb 20 snaps back into its original shape (see FIG. 6).

Referring now to FIG. 6, the castors (not shown) are mounted on the lower leaf 2 directly beneath the substantially cylindrical member 8 such that their swivel axes lie along line A-A. When the trolley is not loaded the hinged steering device assumes the position shown by virtue of the biasing force applied by the elastomeric member (shown in dotted line). The steering device also adopts this position when the trolley (laden or not loaded) is moving in a direction other than forwards. When the castor wheels are pointing in a sideways or backwards direction, an anticlockwise (in the orientation depicted in FIG. 6) tuning moment is produced. In this position the castor swivel axes A-A are vertical and the carrier handles as if the steering device were not present. The hinge leaves 1,2 are prevented from opening further by the interference of the projections 6, 14. In the unlikely event that one or both of the projections 6, 14 fail, articulation is limited by abutment of the shoulders 7a and 11 on the hinge roll 9 and the claw lock 7.

When the carrier is in a laden condition and travelling in a forward direction, the hinge assembly articulates as shown in FIG. 7. The lower leaf 2 rotates about the substantially cylindrical member in a clockwise direction (in the orientation shown in FIG. 7). The elastomeric member (shown in dotted line) is compressed and the castor swivel axes (represented by line B-B are inclined to the vertical thereby introducing a castor angle. Articulation of the leaves 1, 2 is restricted primarily by the abutment of the tip of the limb 20 with the underside of the upper leaf 1. As a secondary means of restricting articulation, the claw lock shoulder 7a abuts the claw lock shoulder 11.

Referring to FIG. 8, the secondary action of the claw lock shoulders 7a, 11 is shown more clearly. As a turning force is applied to the lower leaf 2, the claw lock shoulders 7a, 11 are brought into abutment. As the turning force increases the shoulders prevent further rotation of the hinge roll 9 from about the cylindrical member 8 thereby preventing rotation of the lower leaf 2 relative to the upper leaf 1. The result is that the cylindrical member 8, the hinge roll 9 and both of the claw lock features 7, 11 act mechanically as a single, unitary, solid member, thereby increasing the mechanical strength of the whole. The space between the claw lock 7 and the substantially cylindrical portion is designed to receive part of the hinge roll 9 in snug engagement, the claw lock 7 preventing the hinge roll 9 from flexing or deforming outwardly under load.

The upper leaf 1 has two screw locator holes 23 into which protective the end-caps are attached at each end of the steering device. The end caps preventing ingress of dirt, grit and water, cover any sharp edges to reduce risk of injury/damage (in the event of a collision). Moreover, the end-caps prevent relative lateral movement of the two hinge leaves.

1-28. (canceled)

29. A castor mounting arrangement, for a castored, load-bearing vehicle, the arrangement comprising a fixed member for connection to the vehicle, a rotating member for connection at least one castor and primary stop means for limiting the amount of rotation of the rotating member in both directions, characterised in that the fixed member is connected to the rotating member by a hinged connection comprising an elongate substantially cylindrical member defined on one of the members and a hinge roll defined on the other of the members, the hinge roll partially enveloping the cylindrical member and being rotatable relative thereto.

30. A castor mounting arrangement according to claim 29, wherein said fixed member is an integral part of the load-bearing vehicle.

31. A castor mounting arrangement according to claim 29, wherein said primary stop means comprises a first abutment surface defined on said fixed member and a second abutment surface defined on said rotating member, the rotating member being movable in a first direction towards the fixed member to a first position where first and second abutment surfaces are in abutment and prevent any further rotation in that direction.

32. A castor mounting arrangement according to claim 30, wherein said primary stop means comprises a first abutment surface defined on said fixed member and a second abutment surface defined on said rotating member, the rotating member being movable in a first direction towards the fixed member to a first position where first and second abutment surfaces are in abutment and prevent any further rotation in that direction.

33. A castor mounting arrangement according to claim 31, wherein the first and second abutment surfaces are defined at a position distal from said hinged connection.

34. A castor mounting arrangement according to claim 31, wherein the first and second abutment surfaces are defined by first and second projections, the second projection being received, in use, in a space defined between the first projection and another part of the fixed member.

35. A castor mounting arrangement according to claim 32, wherein the first and second abutment surfaces are defined by first and second projections, the second projection being received, in use, in a space defined between the first projection and another part of the fixed member.

36. A castor mounting arrangement according to claim 35, wherein the second projection is defined on a rigid limb that is able to flex.

37. A castor mounting arrangement according to claim 36, wherein the first and second projections have arcuate surfaces that bear against and pass over one another during assembly of the fixed and rotating members.

38. A castor mounting arrangement according to claim 29, wherein the primary stop means comprises a third abutment surface defined on the fixed member and a fourth abutment surface defined on the rotating member, rotating member being rotatable in a second direction away from the fixed member to a second position where the third and fourth abutment surfaces are in abutment and prevent any further rotation in that direction.

39. A castor mounting arrangement according to claim 29, further comprising secondary stop means, said secondary stop means restricting the degree of rotation of the rotating member relative to the fixed member in either direction.

40. A castor mounting arrangement according to claim 39, wherein said secondary stop means comprises fifth and sixth abutment surfaces, one defined on the fixed member and the other defined on the rotating member.

41. A castor mounting arrangement according to claim 37, wherein said secondary stop means acts simultaneously with said primary stop means to restrict rotation of the rotating member in a first direction towards the fixed member.

42. A hinged steering mechanism according to claim 40, wherein there is provided a claw lock that prevents the hinge roll from uncurling.

43. A hinged steering mechanism according to claim 41, wherein there is provided a claw lock that prevents the hinge roll from uncurling.

44. A castor mounting arrangement according to claim 42, wherein the claw lock defines part of the secondary stop means.

45. A castor mounting arrangement according to claim 43, wherein the claw lock defines the fifth abutment surface and wherein the hinge roll defines the sixth abutment surface.

46. A castor mounting arrangement according to claim 40, wherein said secondary stop means does not act simultaneously with said primary stop means to restrict rotation of the rotating member in a second direction away from the fixed member but instead is present as a failsafe mechanism that restricts rotation in the second direction in the event of failure of said primary stop means.

47. A castor mounting arrangement according to claim 29, further comprising a biasing member disposed between said fixed and said rotating member.

48. A castor mounting arrangement according to claim 47, wherein said biasing member is formed from an elastomeric material.

49. A castor mounting arrangement according to claim 47, wherein said rotating member is rotatable relative to the fixed member from a first position to a second position, the members being closer together in the second position, and the biasing member is under compression between said fixed and rotating members at the first position such that the arrangement withstand a predetermined load before rotation towards the second position commences.

50. A castor mounting arrangement according to claim 29, wherein one or more of said fixed and rotating members comprises an extruded profile.

51. A castor mounting arrangement according to claim 50, wherein both said fixed member and said rotating member comprise an extruded profile.

52. A castor mounting arrangement according to claim 50, wherein said one or more extruded profile is an extruded aluminium profile.

53. A castor mounting arrangement according to claim 29, further comprising one or more end-caps for covering substantially an entire open end of said members.

54. A castor mounting arrangement according to claim 29, wherein the fixed member has a downward apron along its rear edge.

55. A castor mounting arrangement according to claim 29 wherein said rotating member further comprises a tubular portion disposed beneath said hinge roll.

56. A castor assembly for a load-bearing vehicle comprising at least one castor having a wheel that is rotatable about an axle and is swivel mounted on a swivel axis, and a castor mounting arrangement according to claim 29.

57. A load bearing vehicle comprising a chassis to which is connected a castor assembly as defined in claim 56.

58. A method of assembling a castor mounting arrangement having fixed and rotating members connectable by a hinged connection comprising a substantially cylindrical member being defined one of the fixed or rotating members and a hinge roll being defined on the other, the arrangement having primary stop means comprising a first projection on the fixed member and a second projection on the rotating member, the method comprising the steps attaching the fixed and rotating members at the hinged connection member such that the cylindrical member is received in and is partially enveloped by the hinge roll, rotating the rotating member about the hinge connection in a first direction towards the fixed member until the first and second projections contact one another, rotating the rotating member further in said first direction so that first and second projections slide past one another, further movement thereafter of the rotating member in either direction being limited.

59. A method according to claim 58, further comprising the step of inserting a biasing member into one of said members, prior to connecting said fixed and rotating members together.
